(19) United States
(12) Patent Application Publication
(10) Pub. No.: US 2018/0248742 A1
(43) Pub. Date: Aug. 30, 2018

(54) Non-Disruptive IQ Mismatch Calibration

(71) Applicant: MediaTek Inc., Hsinchu City (TW)

(72) Inventor: Ming Lei, San Jose, CA (US)

(21) Appl. No.: 15/903,188

(22) Filed: Feb. 23, 2018

Related U.S. Application Data
(60) Provisional application No. 62/463,007, filed on Feb. 24, 2017.

(51) Int. Cl. H04L 27/36; H04L 27/38; H04B 17/11

(52) U.S. Cl. CPC H04L 27/364; H04B 1/0475; H04B 17/11; H04L 27/3863

(57) ABSTRACT

Concepts and examples pertaining to non-disruptive calibration and tuning of communication devices are described. A processor of an apparatus performs wireless communication with another apparatus using a wireless communication device of the apparatus. The processor also performs, in real time, calibration on the wireless communication device using coherent and non-coherent sampling averages to split a total calibration time into a plurality of short periods to improve reliability. Alternatively, or additionally, the processor performs calibration or radio-frequency (RF) tuning on the wireless communication device during a plurality of idle periods of the wireless communication.

### CROSS REFERENCE TO RELATED PATENT APPLICATIONS

The present disclosure claims the priority benefit of U.S. Provisional Patent Application Ser. No. 62/463,007, filed 24 Feb. 2017, which is incorporated by reference in its entirety.

### TECHNICAL FIELD

The present disclosure is generally related to wireless communication and, more particularly, to non-disruptive calibration and tuning of communication devices.

### BACKGROUND

Unless otherwise indicated herein, approaches described in this section are not prior art to the claims listed below and are not admitted as prior art by inclusion in this section.

As wideband and high-level modulation schemes are used in wireless communication systems, in-phase (I) and quadrature (Q) signal mismatch, especially frequency-dependent (FD) IQ mismatch, becomes one of the major radio-frequency (RF) impairments. Moreover, specification for image rejection ratio (IRR) is becoming tougher and tougher. As temperature change tends to cause IQ mismatch (and IRR) drifts, it is challenging to maintain IRR without service blackout. Furthermore, due to higher requirements, the calibration time for advanced wireless communication systems has become longer and longer.

In direct conversion receivers, an IQ signal is generated by a mixer and is then processed in analog baseband. Given the IQ mismatch or imbalance in the mixer and analog baseband design, a received signal is distorted by its mirror image.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose various novel concepts and schemes pertaining to non-disruptive calibration or tuning of communication devices.

In one aspect, a method may involve a processor of an apparatus performing wireless communication with another apparatus using a wireless communication device of the apparatus. The method may also involve the processor performing, in real time, calibration on the wireless communication device using coherent and non-coherent sampling averages to split a total calibration time into a plurality of short periods to improve reliability.

In one aspect, a method may involve a processor of an apparatus performing wireless communication with another apparatus using a wireless communication device of the apparatus. The method may also involve the processor performing calibration or radio-frequency (RF) tuning on the wireless communication device during a plurality of idle periods of the wireless communication.

In one aspect, an apparatus may include a communication device and a processor coupled to control operations of the communication device. The communication device may be capable of communicating with at least one apparatus, with the communicating involving transmitting data, receiving data, or both transmitting and receiving data. The processor may be capable of communicating with the at least one apparatus using the communication device. The processor may also be capable of performing in real time non-disruptive calibration of the communication device such that communications with the at least one apparatus is not disrupted by the calibration.

It is noteworthy that, although description provided herein may be in the context of IQ mismatch calibration, the proposed concepts, schemes and any variation(s)/derivative(s) thereof may be implemented in other types of calibrations and/or tuning, wherever suitable. Moreover, although description provided herein may be in the context of wireless communications (e.g., Wi-Fi) or certain modulation schemes (e.g., orthogonal frequency-division multiplexing (OFDM)), the proposed concepts, schemes and any variation(s)/derivative(s) thereof may be implemented in other types of communications (e.g., wired communications or other radio-frequency (RF) communications different from Wi-Fi) and/or modulation schemes, wherever suitable. Thus, the scope of the proposed schemes is not limited to the description provided herein.

### BRIEF DESCRIPTION OF THE DRAWINGS

The accompanying drawings are included to provide a further understanding of the present disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a simplified block diagram of an example architecture for non-disruptive calibration in accordance with an implementation of the present disclosure.

FIG. 2 is a flowchart of an example procedure for non-disruptive calibration in accordance with an implementation of the present disclosure.

FIG. 3 is a simplified block diagram of an example architecture in which non-disruptive calibration in accordance with an implementation of the present disclosure may be implemented.

FIG. 4 is a simplified block diagram of an example architecture in which non-disruptive calibration in accordance with an implementation of the present disclosure may be implemented.

FIG. 5 is a simplified block diagram of an example system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under a proposed scheme of the present disclosure, an oscillator (TTG) may be utilized to generate testing signals to estimate frequency-independent (FI)/frequency-dependent (FD) mismatch. Accordingly, power-on calibration may achieve good IRR after calibration. Additionally, the same calibration scheme and algorithm may be utilized to track IRR change in real time during idle periods of wireless signals. In short idle periods, signals may be averaged in both time domain and frequency domain in order to obtain high signal-to-noise ratio (SNR) required by high IRR. The average time in time domain may be very short (e.g., ˜5 μs) in order to fit into short idle periods. The average time in frequency domain may be as much as necessary to achieve required performance. The proposed scheme may be utilized for other calibrations and RF tuning without interrupting normal operations.

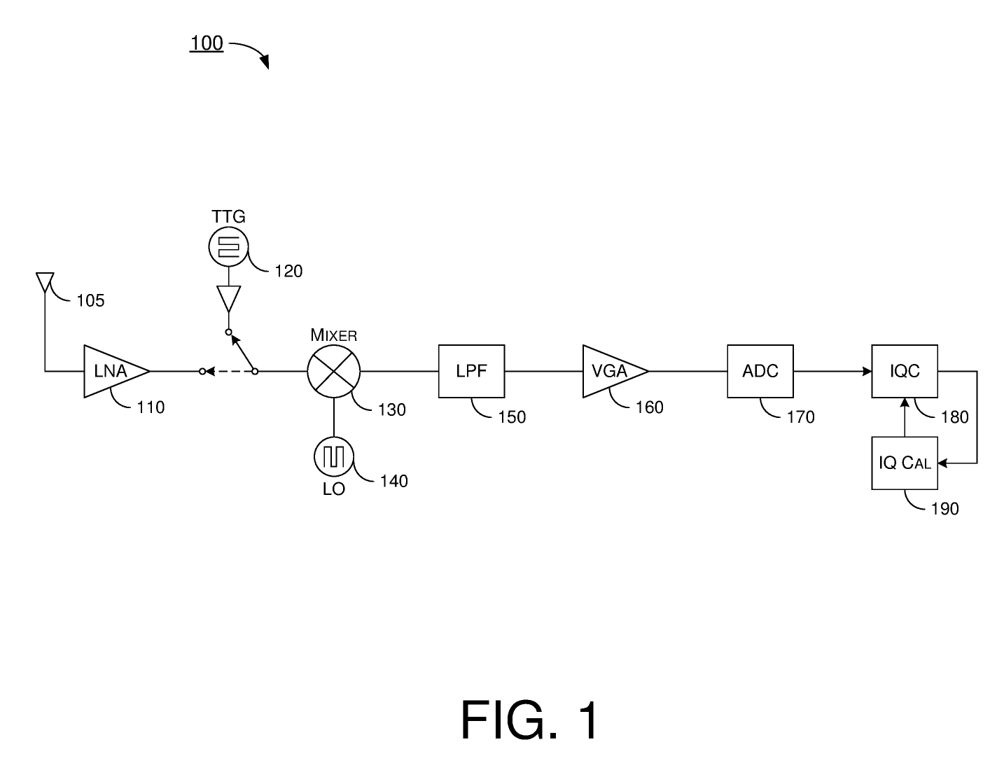

FIG. 1 illustrates an example architecture 100 for non-disruptive calibration in accordance with an implementation of the present disclosure. In some implementations, architecture 100 may be utilized for non-disruptive IQ mismatch calibration. Referring to FIG. 1, from left to right, architecture 100 may include an antenna 105, a low-noise amplifier (LNA) 110, a test tone generation (TTG) oscillator 120, a mixer 130, a local oscillator (LO) 140, a low-pass filter (LPF) 150, a variable-gain amplifier (VGA) 160, an analog-to-digital converter (ADC) 170, an IQ compensation circuit (IQC) 180, and an IQ calibration circuit (IQ CAL) 190. Under the proposed scheme, architecture 100 may be utilized to perform dynamic non-disruptive IQ mismatch calibration. Specifically, the input of mixer 130 may be switched to LNA 110 before TX/RX packets. Additionally, the input of mixer 130 may be switched to TTG oscillator 120 after TX/RX packets.

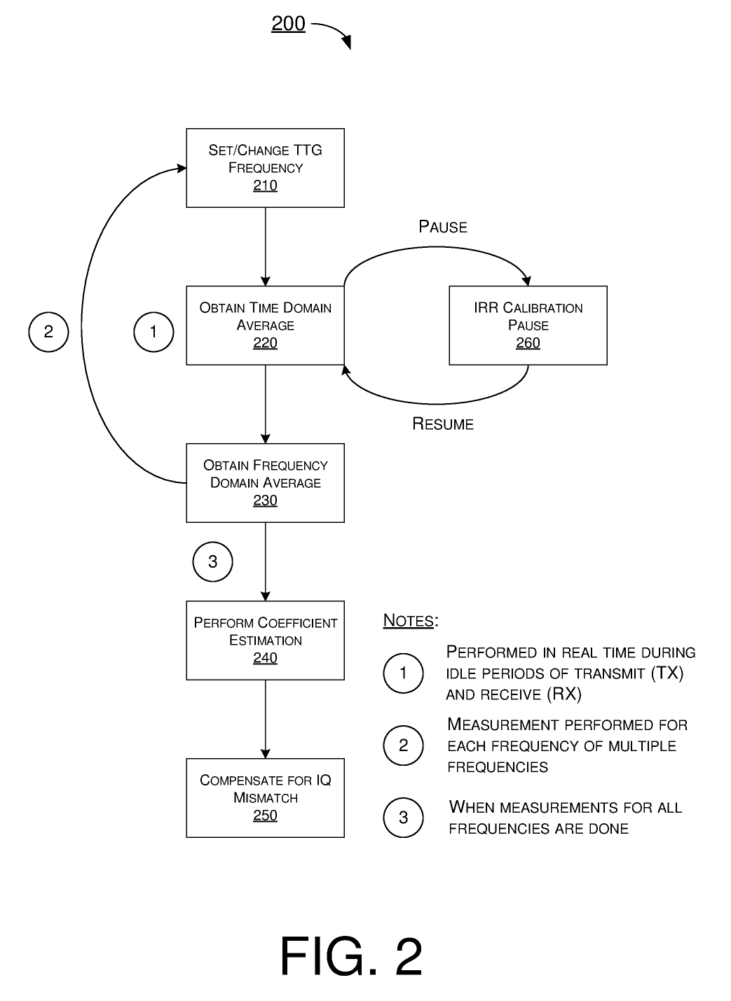

FIG. 2 illustrates an example procedure 200 for non-disruptive calibration in accordance with an implementation of the present disclosure. Procedure 200 may represent an aspect of implementing the proposed concepts and schemes with respect to non-disruptive IQ mismatch calibration. Procedure 200 may involve one or more operations, actions, or functions as illustrated by one or more of blocks 210, 220, 230, 240, 250 and 260. Although illustrated as discrete blocks, various blocks of procedure 200 may be divided into additional blocks, combined into fewer blocks, or eliminated, depending on the desired implementation. Moreover, the blocks/sub-blocks of procedure 200 may be executed in the order shown in FIG. 2 or, alternatively in a different order. Alternatively, or additionally, the blocks/sub-blocks of procedure 200 may be executed iteratively. Procedure 200 may be implemented by or in architecture 100 as well as any variations thereof. In some implementations, procedure 200 may be executed in the digital domain in digital circuits of a transceiver, receiver and/or transmitter in which procedure 200 is implemented. Solely for illustrative purposes and without limiting the scope, procedure 200 is described below in the context of architecture 100. Procedure 200 may begin at block 210.

At 210, procedure 200 may involve setting or otherwise changing the frequency of TTG oscillator 120. Procedure 200 may proceed from 210 to 220.

At 220, procedure 200 may involve calculating, determining or otherwise obtaining an average time in time domain. This may be performed in real time during idle periods of TX and RX. Procedure 200 may proceed from 220 to 230 and/or 260.

At 230, procedure 200 may involve calculating, determining or otherwise obtaining an average time in frequency domain. Upon completion of obtaining the average time in both the time domain and frequency domain for a given frequency, procedure 200 may proceed from 230 to 210 to obtain the average time in the time domain and the frequency domain for a different frequency. Upon completion of obtaining the average times in both the time domain and frequency domain for a set of frequencies, procedure 200 may proceed from 230 to 240.

At 240, procedure 200 may involve performing coefficient estimation for a number of calibration coefficients, e.g., by applying inverse fast Fourier transformation (IFFT). Procedure 200 may proceed from 240 to 250.

At 250, procedure 200 may involve performing compensation to achieve non-disruptive IQ mismatch calibration.

At 260, procedure 200 may involve pausing the obtaining of the average time in the time domain and, instead, performing IRR calibration. The IRR calibration may be performed in real time during idle periods of TX and RX. Procedure 200 may proceed from 260 to 220 to resume the obtaining of the average time in the time domain (and frequency domain).

Accordingly, by implementing procedure 200 in architecture 100, the frequency of TTG oscillator 120 may be controlled or otherwise set to change from one frequency to another frequency of multiple frequencies to calibrate the frequency dependency of IRR behavior of a receiver of a communication device. Time domain averaging may then be performed, for a number of times, to gather calibration results. After time-domain averaging, fast Fourier transformation (FFT) or discrete Fourier transformation (DFT) may be performed to convert signals from time domain to frequency domain. Measurement results in the frequency domain (e.g., measured a hundred times to enhance SNR) may be averaged for a given frequency. Once the measurement for a given frequency is complete, the frequency of TTG oscillator 120 may be set to another frequency among the multiple frequencies for measurement of behavior at that frequency. Afterwards, IFFT or other signal processing may be applied to calibrate a coefficient for compensation. IQ imbalance may be compensated using the coefficient. Alternatively, RF tuning may be performed using the coefficient.

Architecture 100 and procedure 200 may be utilized in a variety of applications. For illustrative purposes and without limiting the scope of the present disclosure, description of a number of applications is provided below.

With respect to receiver IRR tracking, architecture 100 and/or procedure 200 may be utilized in Wi-Fi communication systems. Typically, a Wi-Fi communication system is a carrier-sense multiple access with collision avoidance (CSMA/CA)-based wireless time division duplex (TDD) system. This characteristic results in both the Wi-Fi access point and stations having many time slots during which the physical (PHY) layer thereof is idle. Given that the measurement time in the time domain can be very short (e.g., 5 μs), the idle time slots may be utilized to complete one or more coherent averages. That is, receiver IRR calibration may be spread over different idle time slots without impacting normal operations of the Wi-Fi access point and/or stations.

With respect to calibration time, when TTG oscillator 120 switches from a first frequency to a second frequency, it usually takes time for TTG oscillator 120 to settle to the second frequency. Thus, TTG signal may have frequency error without sufficient waiting time. In an event that the average time in the time domain is excessively long (as required to obtain enough SNR), signal may be attenuated or even completely suppressed when the frequency error is large. As such, SNR and calibrated IRR may be degraded. Under the proposed schemes and concepts of the present disclosure, short time domain average is used to tolerate large TTG frequency error (e.g., >10 kHz), thereby reducing the waiting time and overall calibration time. Real time tracking may also be used to replace power-on calibration in an event that power-on calibration is not executable in some applications.

With respect to complexity, in OFDM systems, an existing approach also uses real-time frequency domain IQ mismatch compensation. However, this approach is limited to OFDM systems and it is complex if subcarrier number is large. In contrast, under the proposed schemes and concepts of the present disclosure, time domain compensation is utilized. Time domain compensation is simpler than frequency domain compensation and is not limited to OFDM systems.

With respect to DC offset compensation (DCOC), as DC offset changes slowly, DC offset estimation may be performed in some idle periods. Afterwards, results of the estimation may be combined to obtain an accurate DC offset estimation.

With respect to LPF RC calibration, LPF corner frequency tends to drift as temperature changes. In an event that corner frequency changes slowly, the proposed schemes and concepts of the present disclosure may be utilized to perform incremental RC calibration in idle periods and track drift in the corner frequency.

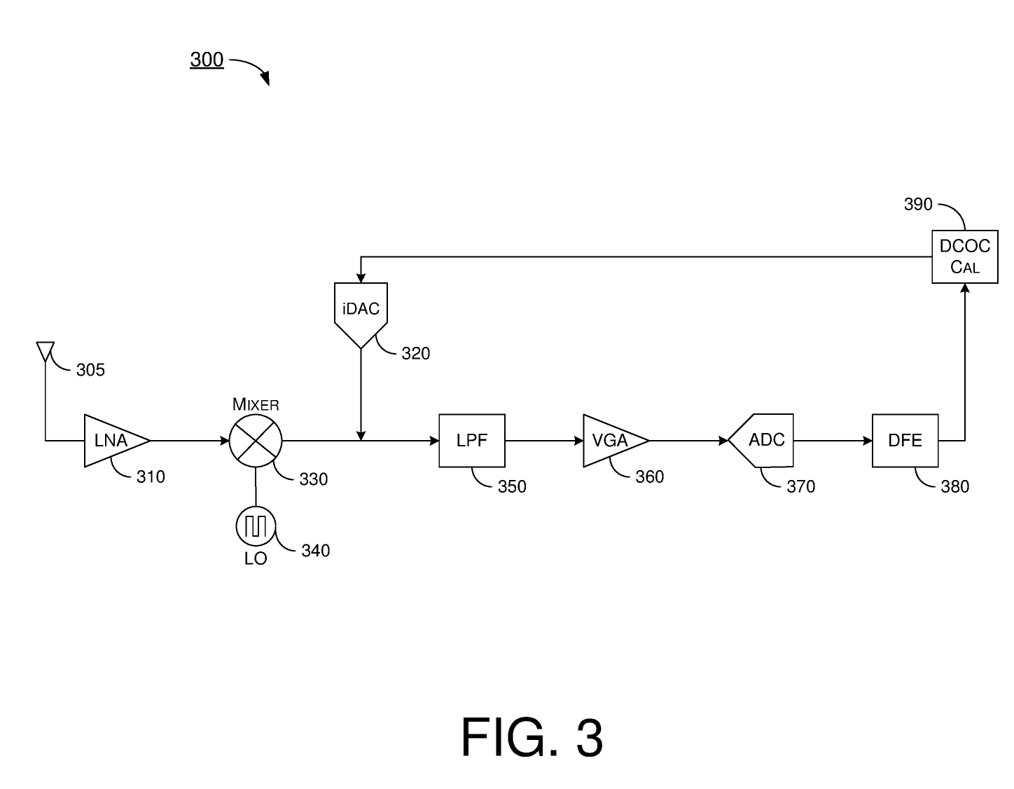

FIG. 3 illustrates an example architecture 300 in which non-disruptive calibration in accordance with an implementation of the present disclosure may be implemented. Referring to FIG. 3, from left to right, architecture 300 may include an antenna 305, a current digital-to-analog converter (iDAC) 320, a LNA 310, a mixer 330, a LO 340, a LPF 350, a VGA 360, an ADC 370, a digital front end (DFE) 380, and a DC offset calibration circuit (DCOC CAL) 390. Under the proposed scheme, architecture 300 may be utilized to perform dynamic non-disruptive DC offset calibration. Specifically, DC offset may be calibrated during idle periods of TX/RX, and a DCOC table may be calibrated by updating the DCOC table in an event that one gain code is finished. Control of iDAC 320 may be switched by the calibrated DCOC table.

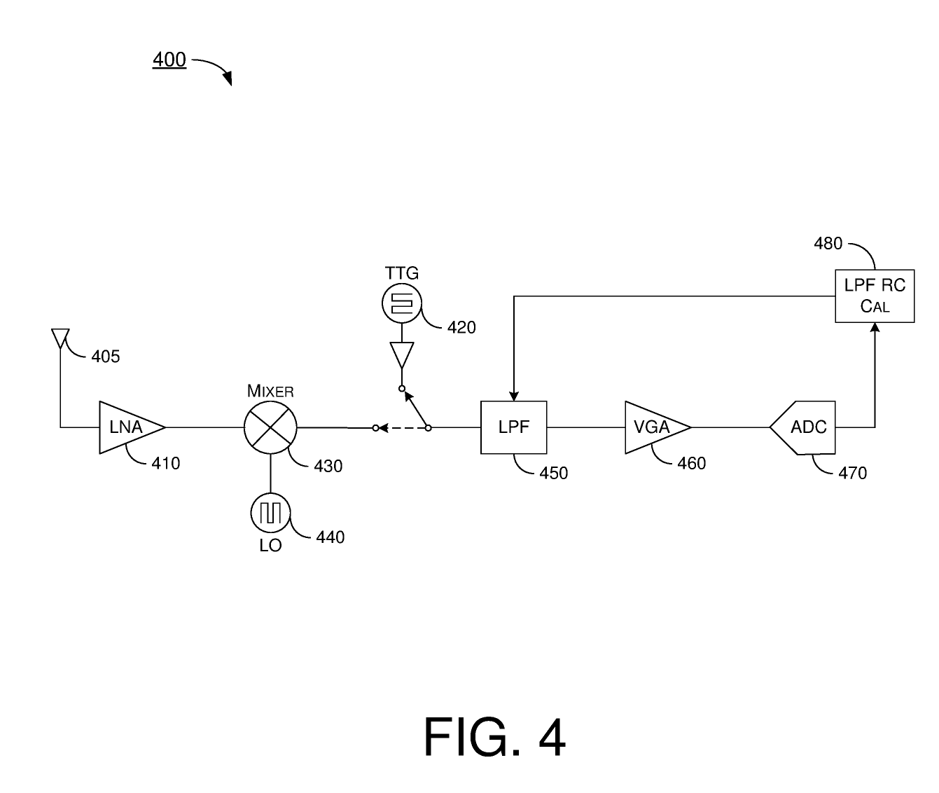

FIG. 4 illustrates an example architecture 400 in which non-disruptive calibration in accordance with an implementation of the present disclosure may be implemented. Referring to FIG. 4, from left to right, architecture 400 may include an antenna 405, a LNA 410, a TTG oscillator 420, a mixer 430, a LO 440, a LPF 450, a VGA 460, an ADC 470, and a LPF RC calibration circuit 480. Under the proposed scheme, architecture 100 may be utilized to perform dynamic non-disruptive LPF RC calibration. Specifically, RC control of LPF 450 may be calibrated during idle periods, and an RC control table may be calibrated by updating the RC control table in an event that calibration is finished. RC control may be switched by the calibrated RC control table.

### Illustrative Implementations

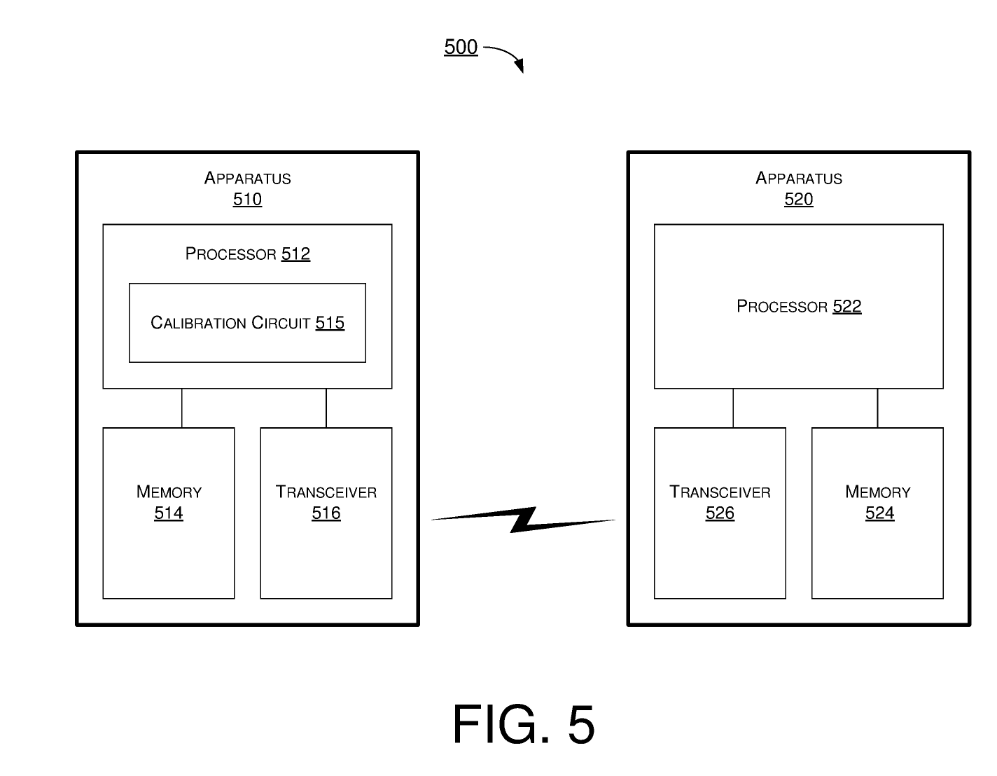

FIG. 5 illustrates an example system 500 having at least an example first apparatus 510 and an example second apparatus 520 in accordance with an implementation of the present disclosure. Each of first apparatus 510 and second apparatus 520 may perform various functions to implement schemes, techniques, processes and methods described herein pertaining to non-disruptive calibration and RF tuning of communication devices, including those described above with respect to FIG. 1-FIG. 4 as well as processes 600 and 700 described below.

First apparatus 510 may be a part of an electronic apparatus, which may be a user equipment (UE) such as a portable or mobile apparatus, a wearable apparatus, a wireless communication apparatus or a computing apparatus. For instance, first apparatus 510 may be implemented in a smartphone, a smartwatch, a personal digital assistant, a digital camera, or a computing equipment such as a tablet computer, a laptop computer or a notebook computer. Alternatively, first apparatus 510 may be a network node such as an access point, base station, small cell, router, gateway, eNodeB or gNB. In some implementations, first apparatus 510 may also be a part of a machine type apparatus, which may be an Internet-of-Things (IoT) apparatus such as an immobile or a stationary apparatus, a home apparatus, a wire communication apparatus or a computing apparatus. For instance, first apparatus 510 may be implemented in a smart thermostat, a smart fridge, a smart door lock, a wireless speaker or a home control center. In some implementations, first apparatus 510 may be implemented in the form of one or more integrated-circuit (IC) chips such as, for example and without limitation, one or more single-core processors, one or more multi-core processors, or one or more complex-instruction-set-computing (CISC) processors. First apparatus 510 may include at least some of those components shown in FIG. 5 such as a processor 512, for example. First apparatus 510 may further include one or more other components not pertinent to the proposed scheme of the present disclosure (e.g., internal power supply, display device and/or user interface device), and, thus, such component(s) of first apparatus 510 are neither shown in FIG. 5 nor described below in the interest of simplicity and brevity.

Second apparatus 520 may be a part of an electronic apparatus, which may be a network node such as an access point, base station, small cell, router, gateway, eNodeB or gNB. For instance, second apparatus 520 may be implemented in an eNodeB in a LTE, LTE-Advanced or LTE-Advanced Pro network or in a gNB in a 5G, NR, IoT or NB-IoT network. Alternatively, second apparatus 520 may be a part of an electronic apparatus, which may be a UE such as a portable or mobile apparatus, a wearable apparatus, a wireless communication apparatus or a computing apparatus. For instance, second apparatus 520 may be implemented in a smartphone, a smartwatch, a personal digital assistant, a digital camera, or a computing equipment such as a tablet computer, a laptop computer or a notebook computer. In some implementations, second apparatus 520 may be implemented in the form of one or more IC chips such as, for example and without limitation, one or more single-core processors, one or more multi-core processors, or one or more CISC processors. Second apparatus 520 may include at least some of those components shown in FIG. 5 such as a processor 522, for example. Second apparatus 520 may further include one or more other components not pertinent to the proposed scheme of the present disclosure (e.g., internal power supply, display device and/or user interface device), and, thus, such component(s) of second apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including non-disruptive calibration and RF turning in accordance with various implementations of the present disclosure.

In some implementations, first apparatus 510 may also include a transceiver 516, as a communication device, coupled to processor 512 and capable of wirelessly transmitting and receiving data. In some implementations, first apparatus 510 may further include a memory 514 coupled to processor 512 and capable of being accessed by processor 512 and storing data therein. In some implementations, second apparatus 520 may also include a transceiver 526, as a communication device, coupled to processor 522 and capable of wirelessly transmitting and receiving data. In some implementations, second apparatus 520 may further include a memory 524 coupled to processor 522 and capable of being accessed by processor 522 and storing data therein. Accordingly, first apparatus 510 and second apparatus 520 may wirelessly communicate with each other via transceiver 516 and transceiver 526, respectively. That is, each of transceiver 516 and transceiver 526 may be capable of communicating with each other by transmitting data, receiving data, or both transmitting and receiving data.

Referring to FIG. 5, processor 512 of first apparatus 510 may include a calibration circuit 515 configured, designed, adapted or otherwise capable of performing various operations for non-disruptive calibration and RF tuning in accordance with the present disclosure. In some implementations, processor 512 may communicate with second apparatus 520 using transceiver 516. Moreover, calibration circuit 515 of processor 512 may perform, in real time, non-disruptive calibration of transceiver 516 such that communications with second apparatus 520 is not disrupted by the calibration.

In some implementations, in performing the calibration, calibration circuit 515 of processor 512 may perform in-phase (I) and quadrature (Q) signal mismatch calibration.

In some implementations, in performing the calibration, calibration circuit 515 of processor 512 may perform RF turning on the communication device.

In some implementations, each of transceiver 516 and transceiver 526 may be a wireless communication device such that transceiver 516 and transceiver 526 engage in wireless communication with each other. In such cases, in performing the calibration, calibration circuit 515 of processor 512 may perform the calibration using coherent and non-coherent sampling averages by performing a number of operations. For instance, calibration circuit 515 may obtain a coherent sampling average of wireless signals of the wireless communication in a time domain during one or more first idle periods of a plurality of idle periods of the wireless communication. Additionally, calibration circuit 515 may obtain a non-coherent sampling average of the wireless signals of the communication in a frequency domain during one or more second idle periods of the plurality of idle periods of the wireless communication.

In some implementations, in performing the calibration, calibration circuit 515 of processor 512 may set a frequency of an oscillator (e.g., TTG oscillator 120 implemented in calibration circuit 515) to one of a plurality of frequencies. Additionally, calibration circuit 515 may generate, using the oscillator, a test signal at the frequency. Moreover, calibration circuit 515 may perform the non-disruptive calibration to estimate a frequency-independent (FI) and frequency-dependent (FD) mismatch in the communication device of the apparatus (e.g., transceiver 516). In some implementations, in performing the calibration, calibration circuit 515 of processor 512 may also track in real time a change in an IRR associated with the communication device using idle periods of the wireless communication.

In some implementations, in performing the calibration, calibration circuit 515 of processor 512 may perform a number of operations. For instance, calibration circuit 515 may set a frequency of an oscillator to a respective frequency of a plurality of frequencies. Moreover, calibration circuit 515 may perform, for each frequency of the plurality of frequencies, operations including: (1) obtaining a sampling average of wireless signals of the wireless communication in a time domain during one or more first idle periods of a plurality of idle periods of the wireless communication; and (2) obtaining a sampling average of the wireless signals of the wireless communication in a frequency domain during one or more second idle periods of the plurality of idle periods of the wireless communication. Furthermore, calibration circuit 515 may estimate a coefficient for compensation using sampling averages in the time domain for the plurality of frequencies and sampling averages in the frequency domain for the plurality of frequencies. Additionally, calibration circuit 515 may perform one of: (a) performing an IQ mismatch calibration for transceiver 516 using the coefficient; (b) performing a direct current (DC) offset calibration for transceiver 516 using the coefficient; or (c) performing a low-pass filter (LPF) resistance-capacitance (RC) calibration for transceiver 516 using the coefficient.

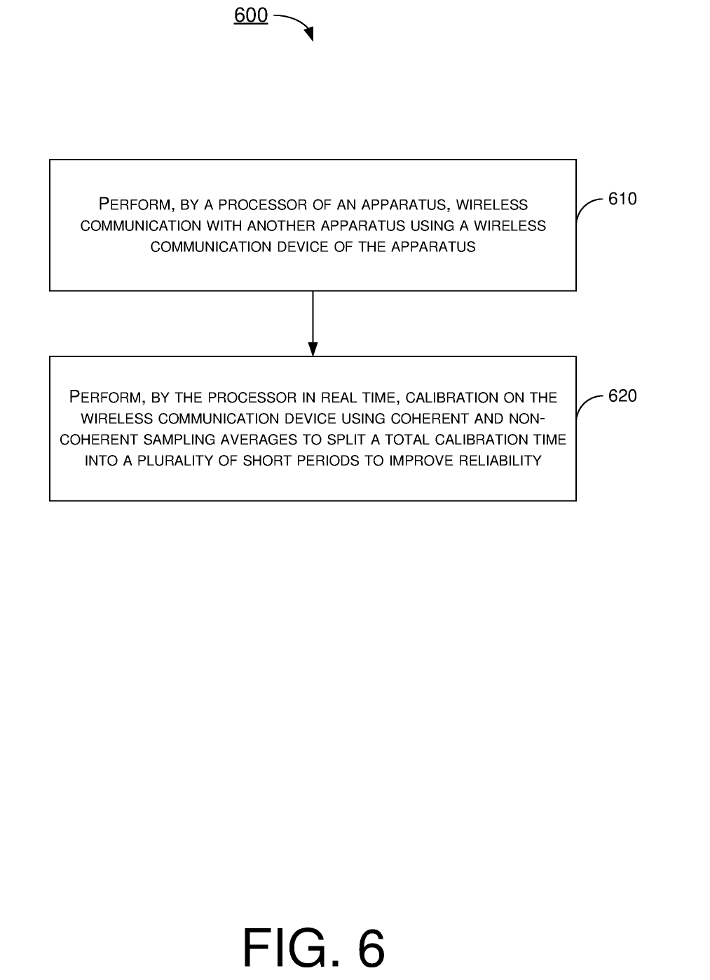

FIG. 6 illustrates an example process 600 in accordance with an implementation of the present disclosure. Process 600 may represent an aspect of implementing the proposed concepts and schemes such as those described with respect to some or all of FIG. 2-FIG. 5. More specifically, process 600 may represent an aspect of the proposed concepts and schemes pertaining to non-disruptive calibration and tuning of communication devices. Process 600 may include one or more operations, actions, or functions as illustrated by one or more of blocks 610 and 620. Although illustrated as discrete blocks, various blocks of process 600 may be divided into additional sub-blocks, combined into fewer blocks, or eliminated, depending on the desired implementation. Moreover, the blocks/sub-blocks of process 600 may be executed in the order shown in FIG. 6 or, alternatively in a different order. The blocks/sub-blocks of process 600 may be executed iteratively. Process 600 may be implemented by or in apparatus 510 as well as any variations thereof. Solely for illustrative purposes and without limiting the scope, process 600 is described below in the context of apparatus 510. Process 600 may begin at block 610.

At 610, process 600 may involve processor 512 of apparatus 510 performing wireless communication with another apparatus (e.g., apparatus 520) using wireless communication device of apparatus 510 (e.g., transceiver 516). Process 600 may proceed from 610 to 620.

At 620, process 600 may involve processor 512 performing, in real time, calibration on the wireless communication device (e.g., transceiver 516) using coherent and non-coherent sampling averages to split a total calibration time into a plurality of short periods to improve reliability.

In some implementations, in performing the calibration, process 600 may involve processor 512 performing in-phase (I) and quadrature (Q) signal mismatch calibration.

In some implementations, in performing the calibration on the wireless communication device using coherent and non-coherent sampling averages, process 600 may involve processor 512 obtaining a coherent sampling average of wireless signals of the wireless communication in a time domain during one or more first idle periods of a plurality of idle periods of the wireless communication. Additionally, process 600 may involve processor 512 obtaining a non-coherent sampling average of the wireless signals of the wireless communication in a frequency domain during one or more second idle periods of the plurality of idle periods of the wireless communication.

In some implementations, in performing the calibration, process 600 may involve processor 512 setting a frequency of an oscillator (e.g., TTG oscillator 120 implemented in calibration circuit 515 of processor 512) to one of a plurality of frequencies. Moreover, process 600 may involve processor 512 generating, using the oscillator, a test signal at the frequency. Furthermore, process 600 may involve processor 512 performing the non-disruptive calibration to estimate a frequency-independent (FI) and frequency-dependent (FD) mismatch in the wireless communication device of apparatus 510. In some implementations, in performing the calibration, process 600 may also involve processor 512 tracking in real time a change in an image rejection ratio (IRR) associated with the wireless communication device using idle periods of the wireless communication.

In some implementations, in performing the calibration, process 600 may involve processor 512 performing a number of operations. For instance, process 600 may involve processor 512 setting a frequency of an oscillator to a respective frequency of a plurality of frequencies. Additionally, process 600 may involve processor 512 performing, for each frequency of the plurality of frequencies, operations including: (1) obtaining a sampling average of wireless signals of the wireless communication in a time domain during one or more first idle periods of a plurality of idle periods of the wireless communication; and (2) obtaining a sampling average of the wireless signals of the wireless communication in a frequency domain during one or more second idle periods of the plurality of idle periods of the wireless communication. Moreover, process 600 may involve processor 512 estimating a coefficient for compensation using sampling averages in the time domain for the plurality of frequencies and sampling averages in the frequency domain for the plurality of frequencies. Furthermore, process 600 may involve processor 512 performing one of: (a) performing an IQ mismatch calibration for the wireless communication device using the coefficient; (b) performing a DC offset calibration for the wireless communication device using the coefficient; or (c) performing a LPF RC calibration for the wireless communication device using the coefficient.

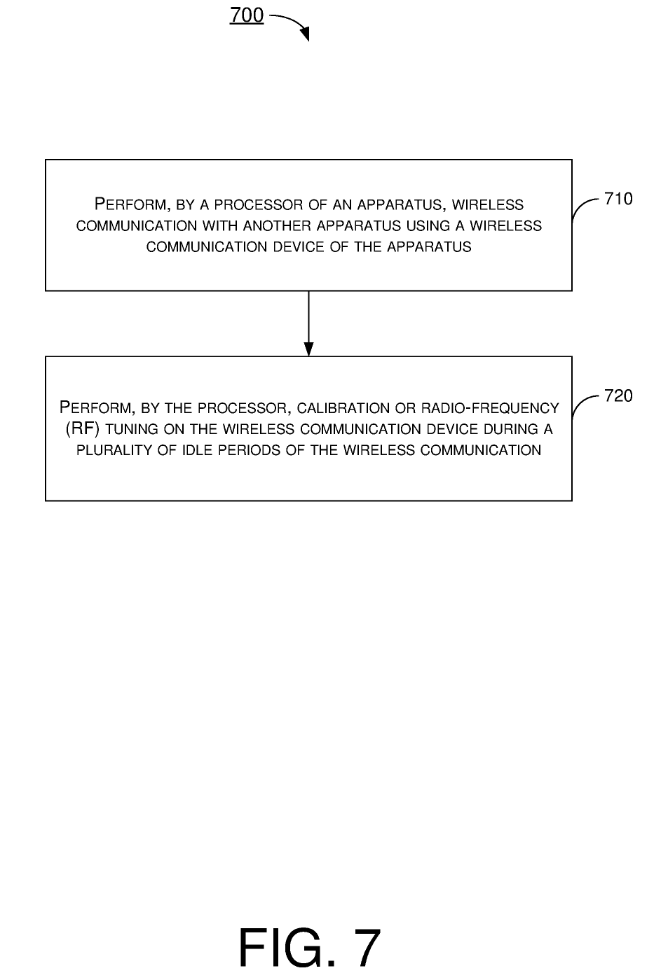

FIG. 7 illustrates an example process 700 in accordance with an implementation of the present disclosure. Process 700 may represent an aspect of implementing the proposed concepts and schemes such as those described with respect to some or all of FIG. 2-FIG. 5. More specifically, process 700 may represent an aspect of the proposed concepts and schemes pertaining to non-disruptive calibration and tuning of communication devices. Process 700 may include one or more operations, actions, or functions as illustrated by one or more of blocks 710 and 720. Although illustrated as discrete blocks, various blocks of process 700 may be divided into additional sub-blocks, combined into fewer blocks, or eliminated, depending on the desired implementation. Moreover, the blocks/sub-blocks of process 700 may be executed in the order shown in FIG. 7 or, alternatively in a different order. The blocks/sub-blocks of process 700 may be executed iteratively. Process 700 may be implemented by or in apparatus 510 as well as any variations thereof. Solely for illustrative purposes and without limiting the scope, process 700 is described below in the context of apparatus 510. Process 700 may begin at block 710.

At 710, process 700 may involve processor 512 of apparatus 510 performing wireless communication with another apparatus (e.g., apparatus 520) using wireless communication device of apparatus 510 (e.g., transceiver 516). Process 700 may proceed from 710 to 720.

At 720, process 700 may involve processor 512 performing calibration or radio-frequency (RF) tuning on the wireless communication device (e.g., transceiver 516) during a plurality of idle periods of the wireless communication.

In some implementations, in performing the calibration or the RF tuning, process 700 may involve processor 512 setting a frequency of an oscillator (e.g., TTG oscillator 120 implemented in calibration circuit 515 of processor 512) to one of a plurality of frequencies. Additionally, process 700 may involve processor 512 generating, using the oscillator, a test signal at the frequency. Moreover, process 700 may involve processor 512 performing the non-disruptive calibration to estimate a frequency-independent (FI) and frequency-dependent (FD) mismatch in the wireless communication device of apparatus 510. In some implementations, in performing the calibration or the RF tuning, process 700 may further involve processor 512 tracking in real time a change in an image rejection ratio (IRR) associated with the wireless communication device using idle periods of the wireless communication.

In some implementations, in performing the calibration or the RF tuning, process 700 may involve processor 512 performing a number of operations. For instance, process 700 may involve processor 512 setting a frequency of an oscillator (e.g., TTG oscillator 120 implemented in calibration circuit 515 of processor 512) to a respective frequency of a plurality of frequencies. Additionally, process 700 may involve processor 512 performing, for each frequency of the plurality of frequencies, operations including: (1) obtaining a sampling average of wireless signals of the wireless communication in a time domain during one or more first idle periods of a plurality of idle periods of the wireless communication; and (2) obtaining a sampling average of the wireless signals of the wireless communication in a frequency domain during one or more second idle periods of the plurality of idle periods of the wireless communication. Moreover, process 700 may involve processor 512 estimating a coefficient for compensation using sampling averages in the time domain for the plurality of frequencies and sampling averages in the frequency domain for the plurality of frequencies. Furthermore, process 700 may involve processor 512 performing one of: (a) performing an in-phase (I) and quadrature (Q) signal mismatch calibration for the wireless communication device using the coefficient; (b) performing a DC offset calibration for the wireless communication device using the coefficient; or (c) performing a LPF RC calibration for the wireless communication device using the coefficient.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, wireless communication with another apparatus using a wireless communication device of the apparatus; and
performing, by the processor in real time, calibration on the wireless communication device using coherent and non-coherent sampling averages to split a total calibration time into a plurality of short periods to improve reliability.

2. The method of claim 1, wherein the performing of the calibration comprises performing in-phase (I) and quadrature (Q) signal mismatch calibration.

3. The method of claim 1, wherein the performing of the calibration on the wireless communication device using coherent and non-coherent sampling averages comprises:
obtaining a coherent sampling average of wireless signals of the wireless communication in a time domain during one or more first idle periods of a plurality of idle periods of the wireless communication; and
obtaining a non-coherent sampling average of the wireless signals of the wireless communication in a frequency domain during one or more second idle periods of the plurality of idle periods of the wireless communication.

4. The method of claim 1, wherein the performing of the calibration comprises:
setting a frequency of an oscillator to one of a plurality of frequencies;
generating, by the oscillator, a test signal at the frequency; and
performing the non-disruptive calibration to estimate a frequency-independent (FI) and frequency-dependent (FD) mismatch in the wireless communication device of the apparatus.

5. The method of claim 4, wherein the performing of the calibration further comprises tracking in real time a change in an image rejection ratio (IRR) associated with the wireless communication device using idle periods of the wireless communication.

6. The method of claim 1, wherein the performing of the calibration comprises:
setting a frequency of an oscillator to a respective frequency of a plurality of frequencies;
performing, for each frequency of the plurality of frequencies, operations comprising:
obtaining a sampling average of wireless signals of the wireless communication in a time domain during one or more first idle periods of a plurality of idle periods of the wireless communication; and
obtaining a sampling average of the wireless signals of the wireless communication in a frequency domain during one or more second idle periods of the plurality of idle periods of the wireless communication; and
estimating a coefficient for compensation using sampling averages in the time domain for the plurality of frequencies and sampling averages in the frequency domain for the plurality of frequencies.

7. The method of claim 6, wherein the performing of the calibration further comprises:
performing one of:
performing an in-phase (I) and quadrature (Q) signal mismatch calibration for the wireless communication device using the coefficient;
performing a direct current (DC) offset calibration for the wireless communication device using the coefficient; or
performing a low-pass filter (LPF) resistance-capacitance (RC) calibration for the wireless communication device using the coefficient.

8. A method, comprising:
performing, by a processor of an apparatus, wireless communication with another apparatus using a wireless communication device of the apparatus; and
performing, by the processor, calibration or radio-frequency (RF) tuning on the wireless communication device during a plurality of idle periods of the wireless communication.

9. The method of claim 8, wherein the performing of the calibration or the RF tuning comprises:
setting a frequency of an oscillator to one of a plurality of frequencies;
generating, by the oscillator, a test signal at the frequency; and
performing the non-disruptive calibration to estimate a frequency-independent (FI) and frequency-dependent (FD) mismatch in the wireless communication device of the apparatus.

10. The method of claim 9, wherein the performing of the calibration or the RF tuning further comprises tracking in real time a change in an image rejection ratio (IRR) associated with the wireless communication device using idle periods of the wireless communication.

11. The method of claim 8, wherein the performing of the calibration or the RF tuning comprises:
setting a frequency of an oscillator to a respective frequency of a plurality of frequencies;
performing, for each frequency of the plurality of frequencies, operations comprising:
obtaining a sampling average of wireless signals of the wireless communication in a time domain during one or more first idle periods of a plurality of idle periods of the wireless communication; and
obtaining a sampling average of the wireless signals of the wireless communication in a frequency domain during one or more second idle periods of the plurality of idle periods of the wireless communication; and
estimating a coefficient for compensation using sampling averages in the time domain for the plurality of frequencies and sampling averages in the frequency domain for the plurality of frequencies.

12. The method of claim 11, wherein the performing of the calibration or the RF tuning further comprises:
performing one of:
performing an in-phase (I) and quadrature (Q) signal mismatch calibration for the wireless communication device using the coefficient;
performing a direct current (DC) offset calibration for the wireless communication device using the coefficient; or
performing a low-pass filter (LPF) resistance-capacitance (RC) calibration for the wireless communication device using the coefficient.

13. An apparatus, comprising:
a communication device capable of communicating with at least one apparatus, the communicating comprising transmitting data, receiving data, or both transmitting and receiving data; and
a processor coupled to control operations of the communication device, the processor capable of operations comprising:
communicating with the at least one apparatus using the communication device; and
performing in real time non-disruptive calibration of the communication device such that communications with the at least one apparatus is not disrupted by the calibration.

14. The apparatus of claim 13, wherein, in performing the calibration, the processor performs in-phase (I) and quadrature (Q) signal mismatch calibration.

15. The apparatus of claim 13, wherein, in performing the calibration, the processor performs radio-frequency (RF) turning on the communication device.

16. The apparatus of claim 13, wherein the communication device is capable of wireless communication, and wherein, in performing the calibration, the processor performs the calibration using coherent and non-coherent sampling averages by performing operations comprising:
obtaining a coherent sampling average of wireless signals of the wireless communication in a time domain during one or more first idle periods of a plurality of idle periods of the wireless communication; and
obtaining a non-coherent sampling average of the wireless signals of the communication in a frequency domain during one or more second idle periods of the plurality of idle periods of the wireless communication.

17. The apparatus of claim 13, wherein, in performing the calibration, the processor performs operations comprising:
setting a frequency of an oscillator to one of a plurality of frequencies;
generating, by the oscillator, a test signal at the frequency; and
performing the non-disruptive calibration to estimate a frequency-independent (FI) and frequency-dependent (FD) mismatch in the communication device of the apparatus.

18. The apparatus of claim 17, wherein the communication device is capable of wireless communication, and wherein, in performing the calibration, the processor further tracks in real time a change in an image rejection ratio (IRR) associated with the communication device using idle periods of the wireless communication.

19. The apparatus of claim 13, wherein, in performing the calibration, the processor performs operations comprising:
setting a frequency of an oscillator to a respective frequency of a plurality of frequencies;
performing, for each frequency of the plurality of frequencies, operations comprising:
obtaining a sampling average of wireless signals of the wireless communication in a time domain during one or more first idle periods of a plurality of idle periods of the wireless communication; and
obtaining a sampling average of the wireless signals of the wireless communication in a frequency domain during one or more second idle periods of the plurality of idle periods of the wireless communication; and
estimating a coefficient for compensation using sampling averages in the time domain for the plurality of frequencies and sampling averages in the frequency domain for the plurality of frequencies.

20. The apparatus of claim 19, wherein, in performing the calibration, the processor further performs operations comprising:
performing one of:
performing an in-phase (I) and quadrature (Q) signal mismatch calibration for the wireless communication device using the coefficient;
performing a direct current (DC) offset calibration for the wireless communication device using the coefficient; or
performing a low-pass filter (LPF) resistance-capacitance (RC) calibration for the wireless communication device using the coefficient.
